(19) United States
(12) Patent Application Publication
(10) Pub. No.: US 2010/0126320 A1
(43) Pub. Date: May 27, 2010

(54) VACUUM BASED PART SEPARATION

(75) Inventors: Charles Macomber, Plainville, CT (US); Leonid Zeygerman, West Hartford, CT (US)

Correspondence Address: FISH & RICHARDSON PC, P.O. BOX 1022, MINNEAPOLIS, MN, 55440-1022, US

(73) Assignee: TRUMPF, INC., Farmington, CT (US)

(21) Appl. No.: 12/275,841

(22) Filed: Nov. 21, 2008

(51) Int. Cl. B26D 7/06

(52) U.S. Cl. 83/24; 83/100

(57) ABSTRACT

Parts separation devices are provided. The parts separation devices include an array of suction devices and a plurality of skeleton holding devices. The suction devices are selectively releasable from the skeleton by a release force applied by the skeleton holding devices.

### TECHNICAL FIELD

This invention relates to systems and methods for separating cut parts from a surrounding skeleton.

### BACKGROUND

When an array of parts is cut from, for example, a sheet of material, e.g., using a laser cutting device, one separates the cut parts from the surrounding “skeleton,” i.e., the scrap sheet material that surrounds the cut parts. This separation can be done manually, which is labor intensive and slow.

### SUMMARY

The systems and methods disclosed herein provide a simple and cost-effective way of separating cut parts from a skeleton. One can then transfer the cut parts to a desired location.

In one aspect, the invention features a part separation device for separating cut parts from a surrounding skeleton, the device including: a frame defining a vacuum passageway; attached to the frame, an array of suction devices, each suction device being movable between a normal self-sealed position, a pick-up position, and a release position; and, attached to the frame, at least one skeleton holder being configured to apply a release force to the skeleton thereby moving any suction devices in contact with the skeleton from the pick-up position to the release position, thereby releasing the skeleton from the suction devices.

Some implementations include one or more of the following features. Each suction device comprises a member defining a vacuum passage terminating in a suction opening, and at least one spring element configured to bias the member. The suction devices are configured so that, in the pick-up position, the vacuum passage of the member is in flow connection with the vacuum passageway of the frame. The release force acts in a direction opposite to a direction of a suction force of the suction devices. Each of the suction devices comprises a check valve that is movable between a closed position, corresponding to the self-sealed position of the suction device, and an open position. Each of the suction devices comprises a vent configured to allow a small amount of leakage past the check valve when the check valve is in the closed position. Each suction device further comprises a housing, the housing surrounding the member and forming a vacuum chamber between the member and the housing, the vacuum chamber being connected to the suction opening of the member. The spring element comprises a first spring acting between the member and the mount and a second spring acting between the housing and the mount. The member comprises an actuating extension for contacting a work piece to be attached to the suction cup. Each suction device is configured so that the member is movable by the first spring into a release position when a release force is applied to the housing. Each skeleton holder includes an outer housing and an extendable member, telescopically disposed within the housing, the extendable member being configured to apply the release force. The device further comprises a workpiece support configured to support the skeleton. The device further comprises a translation stage configured to move the frame relative to the workpiece support.

In another aspect, the invention features a method for separating a cut piece from a skeleton of a workpiece, the method comprising: supporting the workpiece on a workpiece support; vacuum attaching a first suction device to the cut piece and a second suction device to the skeleton, the suction devices being mounted on a frame; moving the frame away from the workpiece support to pull the cut piece from the skeleton; and, holding the skeleton down against the workpiece support to release the second suction device and separate the cut piece from the skeleton.

Some implementations include one or more of the following features. The method further comprises applying a blow out pressure to the first suction device to release the cut part from the first suction device. Holding the skeleton down comprises actuating a skeleton holder that is mounted on the frame. Actuating the skeleton holder comprises extending an extendable portion of the skeleton holder to maintain contact between the skeleton holder and the skeleton as the frame is moved away from the workpiece support.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 is a perspective view, taken from below, of a part separation device.

FIG. 2 is a side view of a skeleton holder and of a first and a second suction devices, shown in a starting position for a skeleton part.

FIG. 3 is a side view of the skeleton holder and the suction devices of FIG. 2, shown in an evacuation position.

FIG. 4 is a side view of the skeleton holder and the suction devices of FIG. 3, shown in a holding position.

FIG. 5 is a side view of the skeleton holder and the suction devices of FIG. 4, the first suction device being in a release position.

FIG. 6 is a side cross-sectional view of a first embodiment of the suction device, shown in an evacuation position.

FIG. 7 is a side cross-sectional view of the first embodiment, shown in a holding position.

FIG. 8 is a side cross-sectional view of the first embodiment, shown in a self-sealed position.

FIG. 9 is a side cross-sectional view of a second embodiment of a releasable suction device, shown in an initial position.

FIG. 10 is a side cross-sectional view of the second embodiment, shown in an evacuation position.

FIG. 11 is a side cross-sectional view of the second embodiment, shown in a holding position.

### DETAILED DESCRIPTION

The part separation devices described herein allow cut parts to be automatically separated from a surrounding skeleton. A part separation device includes a frame on which suction devices are mounted. The suction devices grip the cut parts and skeleton by vacuum. Skeleton holders, which are also mounted to the frame, hold the skeleton down and thereby allow the suction devices to pull the cut parts from the skeleton.

As will be discussed in detail below, the suction devices are designed to automatically release an attached element (skeleton or cut part) under certain conditions. Thus, any suction devices that have gripped the skeleton can release it while the cut parts continue to be attached to the remaining suction devices.

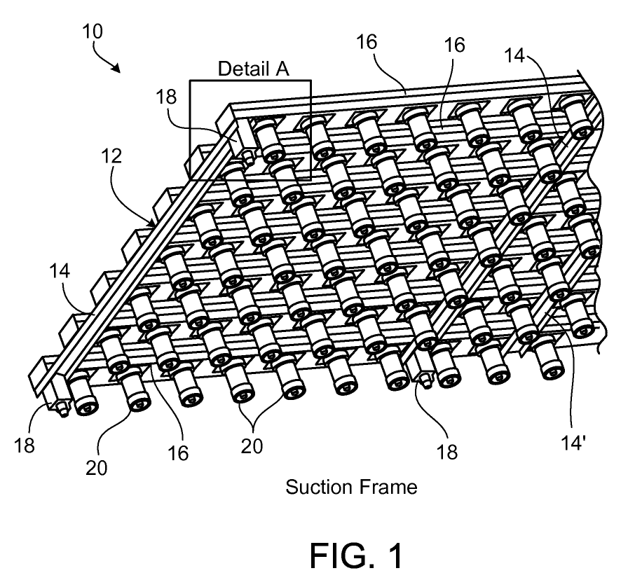

Referring to FIG. 1, a part separation device 10 includes a frame 12 that is made up of a few, widely spaced frame members 14, extending in a first direction, and many closely spaced, vacuum members 16 disposed generally perpendicular to the frame members 14. A plurality of releasable suction devices 20, the structure of which will be described in detail below, are mounted on the vacuum members 16. A pair of a skeleton holder 18 and a suction device 20 is indicated in FIG. 1 in detail A. In the example shown in FIG. 1, the suction devices are distributed as a closely spaced array. Skeleton holders 18, e.g., solenoids, are mounted on at least some of the frame members 14, for example, at or near the corners, as shown. During a pick up process, the suction devices 20 will attach to cut pieces and to the skeleton as will be discussed in further detail below. The skeleton holder 18 holds the skeleton down, allowing the suction devices to pull up on the cut parts and separate them from the skeleton.

As mentioned above, at some positions suction devices may also attach to the skeleton. To detach a suction device from the skeleton, the skeleton holders 18 hold the skeleton down on the underlying support, e.g., a pallet. The skeleton holder 18 is positioned such that it can apply a holding force to the skeleton when detaching the skeleton from the suction device. For example, by extending its length, the skeleton holder 18 holds the skeleton down as the frame 12 is lifted to pull up on the cut parts. Thus the skeleton holders apply a force to the skeleton and—via the skeleton—to those suction devices 20 attached to the skeleton. The force moves the suction devices to an operating state in which the vacuum is broken, as will be discussed below.

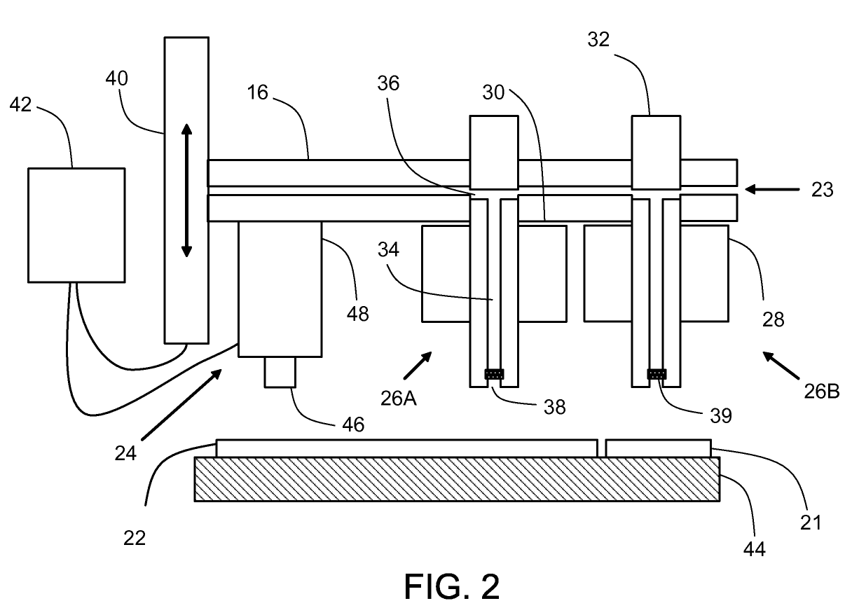

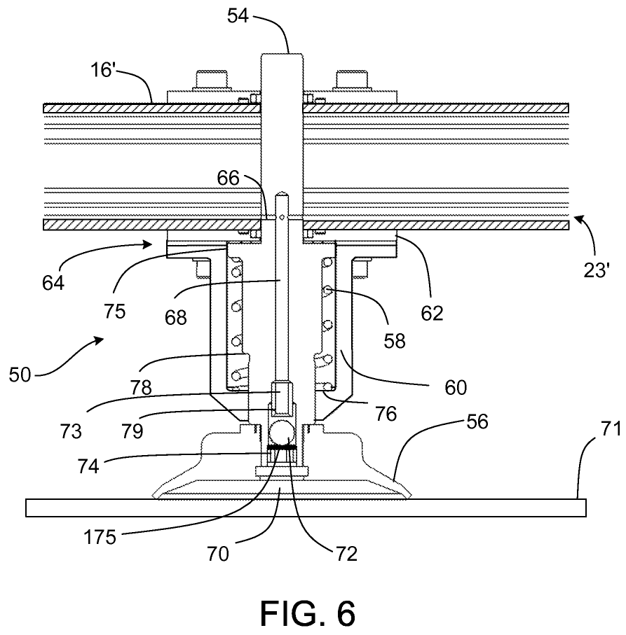

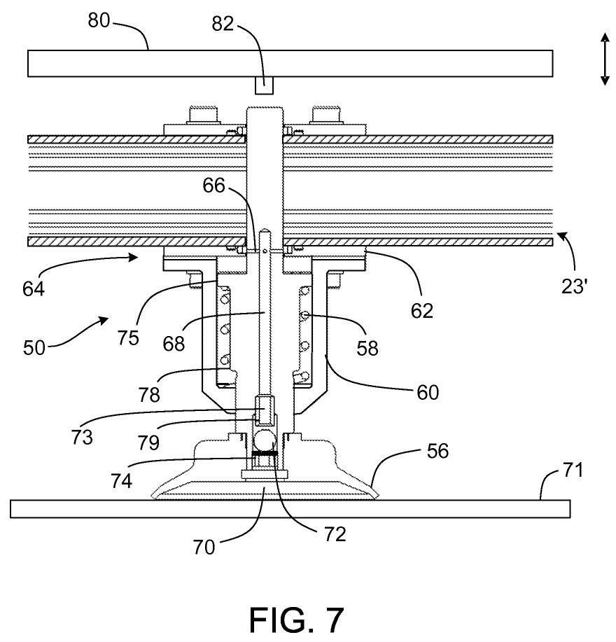

The part separation devices will now be described in further detail with reference to the drawings. We describe first the general concept of the disclosed suction devices, with reference to schematic drawings (FIGS. 2-6), and then two exemplary implementations (shown in FIGS. 6-8 and 9-11).

The operation of the part separation device is illustrated schematically in FIGS. 2-6. The part separation device is configured to selectively separate cut parts 21 from a remaining skeleton 22. The operation is described based on a schematic skeleton holder 24 and two schematic suction devices 26A and 26B. The skeleton holder 24 and the suction device 26A are positioned above the skeleton 22 whereas the suction device 26B is positioned above the cut piece 21.

FIG. 2 also shows a vacuum member 16, on which the skeleton holder 24 and the suction device 26 are mounted. The vacuum member 16 includes a vacuum passage way 23, which is, for example, connected to a vacuum pump such that a vacuum pressure prevails within the vacuum passage way 23. The vacuum passage way 23 thereby represents a vacuum reservoir for the suction device 26.

Each of the suction devices 26A and 26B includes a mount 28 that is mounted to the vacuum member 16 and that provides a ventilation opening 30. Each suction device 26A and 26B further includes a pin 32 that is movable within an opening of the mount 28. The movement is constrained by a spring element, e.g., a spring that is interacting between the mount 28 and the pin 32. The pin 32 provides a vacuum passage 34, e.g. a hole shaped in a t-form that connects first openings 36 with a suction opening 38. The pin 32 also includes a check valve 39 as shown. The check valve may include, for example, a valve element, such as a ball, which is pulled upward by the vacuum against a seat.

In FIG. 2, the vacuum member 16 is mounted to a translation stage 40 of the part separation device. The translation stage 40 is connected to a control unit 42. Thus, moving the translation stage 40 up or down varies the distance between a base plate 44 (and thus the skeleton 22 and cut piece 21) and the suction devices 26A and 26B (specifically, the suction opening 38). This movement also varies the distance between the skeleton holder 24 and the base plate 44. The control unit is further connected with the skeleton holder 24 to control, for example, how far part 46 extends from a body part 48 of the skeleton holder 24.

In FIG. 2, the suction devices 26A and 26B are in an initial operating position, in which the pins 32 are positioned such that the vacuum passage way 23 is in flow connection with the first openings 36. The check valve is in an open position. However, at this point in the process the vacuum source is off. In this example, the initial position is an equilibrium position of the spring element.

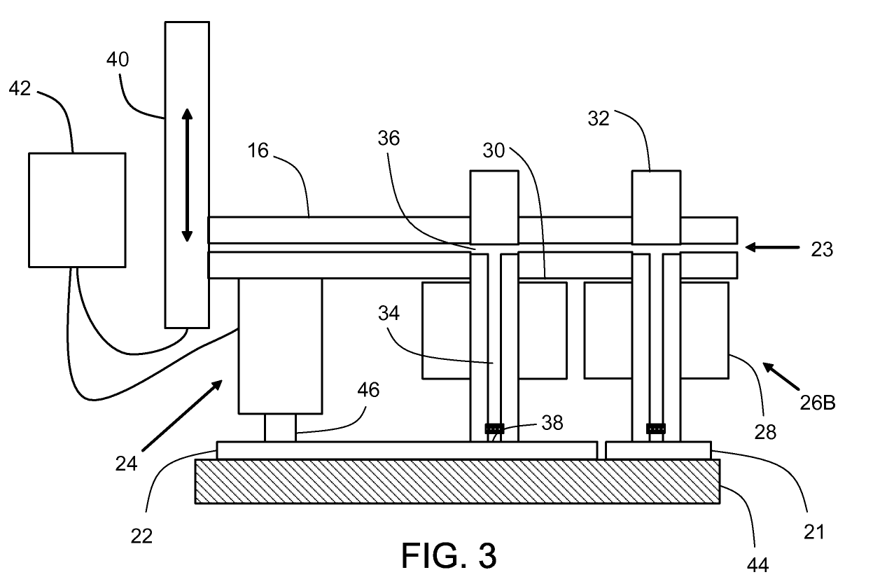

When the translation stage 40 reduces the distance between the pins 32 and the base plate 44, the pins 32 will contact the cut part 21 and the remaining skeleton 22 (FIG. 3). The check valves are configured such that if the first opening 36 is in fluid communication with the vacuum passage way 23 and the suction opening 38 is sealed by a cut part 21 (or the skeleton 22), the check valve remains open. Then, the cut part 21 (or the skeleton 22) is attached to the pin 32 via the vacuum passage 34. An exemplary evacuation position is shown in FIG. 3. If the suction opening 38 is sealed by the skeleton 22 or the cut piece 21, the skeleton 22 or the cut piece 21 will be vacuum attached to the suction device 26A. In general, in the evacuation position, the vacuum passage is connected to the vacuum passage way 23 of the vacuum member 16, thereby connecting the suction opening 38 with a vacuum pressure reservoir.

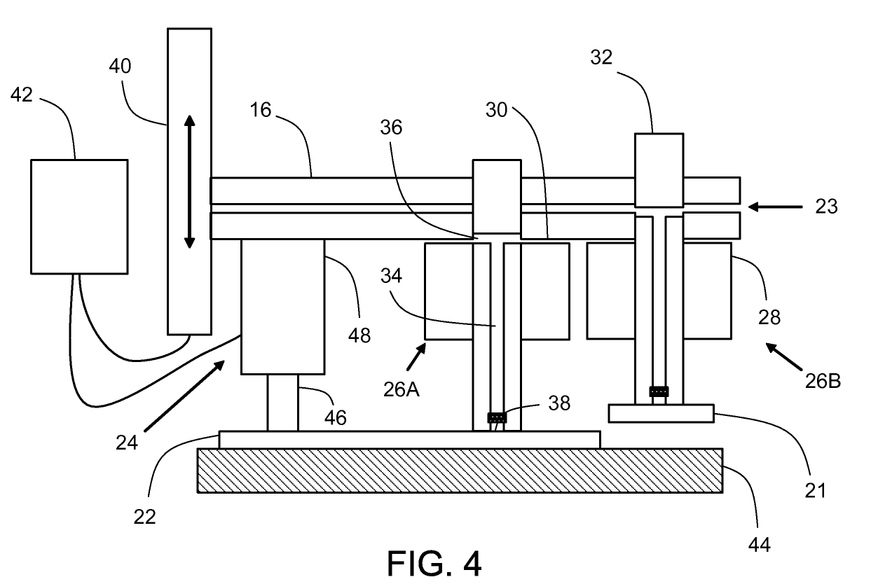

Lifting the vacuum member 16 away from the base plate 44, while maintaining suction, will cause the cut part to be lifted from the base plate 44. This raised position is shown in FIG. 4.

During the lifting, the skeleton holder 46 is holding the skeleton 22 down, and thus the skeleton 22 is not lifted even though it is attached to the suction device 26A. Instead, the pin 32 moves within the mount 28 and vacuum member 16, breaking the vacuum connection between vacuum passage 36 of suction device 26A and the vacuum passageway 23.

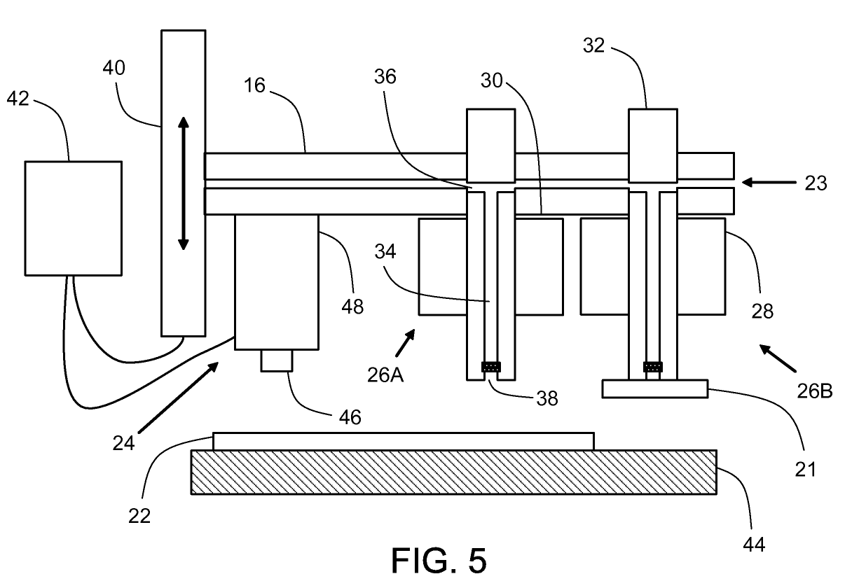

To enable the skeleton 22 to be released from the suction device 26A, the pins 32 are movable with respect to the mount 28 between the evacuation position and a releasing position (FIG. 4). When initiating the release of the skeleton, translation stage 40 moves up and part 46 extends further out of the body part 48. The part 46 moves further out so that it continues to contact skeleton 22 and applies a force to the skeleton. This force holds the skeleton down while the pin 32 of the suction device 26A moves along the mount 28 until the first openings 36 are aligned with the ventilation openings 30 (see FIG. 4). Due to venting through these openings, the vacuum within the vacuum passage 34 breaks and the skeleton 22 is released from being attached to the suction opening 38 (FIG. 5). Meanwhile, the suction device 26B remains attached to the cut piece 21 because the cut piece 21 is not connected to the skeleton 22 and thus is not held down by the skeleton holder 24.

As soon as the skeleton 22 is released, there is no force acting on the pin 32 of the suction device 26A and the spring element causes a movement of the pin 32 of suction device 26A back into the initial position. At this point there is a fluid connection between openings 36 and passageway 23, and as a result the check valve 39 seals the vacuum passage 34. As shown in FIGS. 4 and 5 and discussed above, the vacuum attachment of the cut piece 21 is not affected by the release mechanism. Thus, the suction devices are selectively released or maintained in engagement in order to separate cut piece 21 from the skeleton.

In FIGS. 6-8, a single-spring suction device 50 is shown in different operating states. Suction device 50 is an example of a preferred type of suction device that can be used in the part separation device 10 described above. The single-spring suction device 50 includes a mount unit, a pin 54, a suction cup 56, and a spring 58. The mount unit includes a mount housing 60 and a ring plate 62. Together with the base ring 62, the mount housing 60 is screwed to a vacuum member 16′. Between the mount housing 60 and the ring plate 62, ventilation channels 64 connect the inside of the mount unit with the surrounding atmosphere.

The pin 54 is made of a solid, vacuum tight material. To an end of the pin 54 (herein the “lower end”), the suction cup 56 is vacuum tight attached. Within the pin 54, two intersecting holes 66 penetrate the pin 54 radially, thereby providing a flow connection to a central vacuum channel 68. The vacuum channel 68 is closed at the end opposite to the suction cup (herein the “upper end”) and is in fluid communication with a suction volume 70 defined between the suction cup 56 and an element 71. At the lower end, the vacuum channel 68 is machined so as to incorporate a check valve in which a sealing ball 72 is positioned.

As shown in FIG. 6 an upper valve ring 73 is inserted into the vacuum channel. The ball 72 is blocked from leaving the vacuum channel at the lower end by a stop ring 74. The stop ring 74 also holds a filter disc 175 to keep dirt and debris out of the vacuum system.

The pin 54 is movable along an axis of the suction device 50. The movement of the pin 54 is constrained by the spring 58, which surrounds a center part of the pin 54. An upper end of the spring acts on a flange 75 of the pin 54 while the lower end of the spring 58 acts on a seat 76 of the mount housing 60. The movement of the pin 54 is further limited in one direction by the flange 75 touching the base ring 62, and in the opposite direction by a step 78 of the outer surface of the pin 54 touching the seat 76 of the mount housing 60.

Within the range of possible pin positions, the intersecting holes 66 can move into flow connection with a vacuum passage way 23′ that is formed within the vacuum member 16′ (evacuation position). In some embodiments, the evacuation position can coincide with the flange 75 touching the base ring 62. This position can be the same initial position which the pin 54 adopts due to the force of the spring 58.

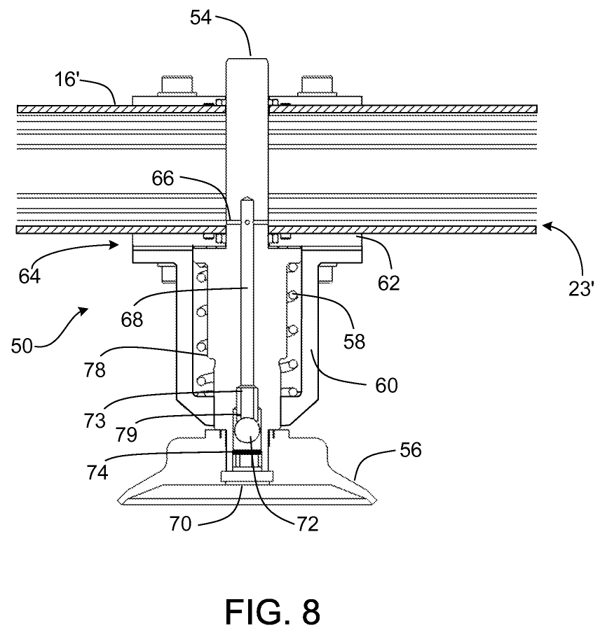

If the intersecting holes 66 are aligned with the vacuum passage way 23′ and no element 71 (cut part or skeleton) seals the suction volume 70, the check valve will be activated by the air sucked into the vacuum channel 68, thereby self-sealing the vacuum system of the part separation device as shown in FIG. 8. The self-sealing can also occur if, for example, the suction cup 56 covers a laser cut line such that the suction volume 70 cannot be sealed and evacuated.

In some cases, the intersecting holes 66 are aligned with the vacuum passage way 23′ and the suction cup 56 only partially seals against the element 71 (marginal sealing conditions). In these cases, the check valve will be deactivated by the air of suction volume 70 being sucked through a tiny hole 79 into the vacuum channel 68. This reduces the pressure difference between the vacuum channel 68 and the suction volume 70 and the sealing ball 72 is released to position in which it does not seal against the ring 73. Then, the vacuum system of the part separation device is in direct flow connection with the suction volume 70 and the element 71 is vacuum attached to the pin 54.

Suction devices that are in the evacuation position can be unsealed by breaking the vacuum in the vacuum passageway 23′, e.g., by blowing compressed air through the vacuum passageway 23′. Such a blow-out cycle allows attached parts to be released quickly and, for example, dropped at a predefined position.

Suction devices to which the skeleton is attached can be unsealed using the skeleton holder 46, shown in FIG. 4 and discussed above. Skeleton holder 46 applies a force to the skeleton which compresses spring 58, aligning holes 66 with channel 68, and thereby moving the pin 54 into the release position.

The suction device described above performs well even under problematic sealing conditions, e.g., when the part to which the suction device is to be sealed is tipped or uneven.

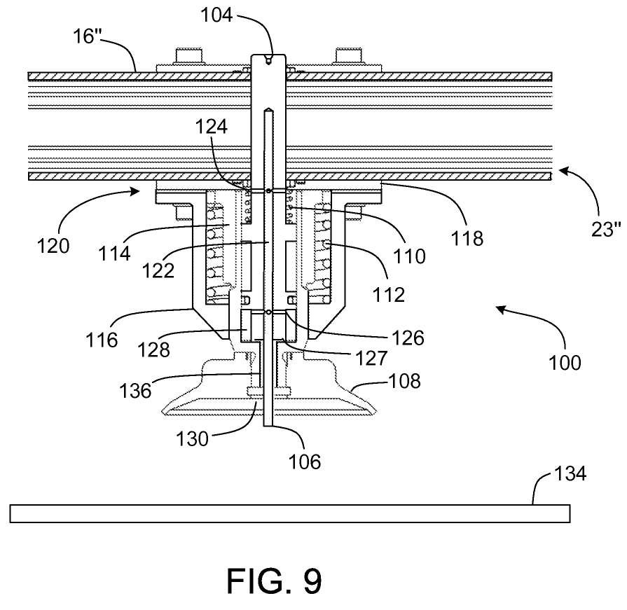

In FIGS. 9-11, an actuating-pin suction device 100 (an alternative type of suction device) is shown in different operating states. The actuating-pin suction device 100 includes a pin 104 with an actuating pin extension 106, a suction cup 108, a first spring 110, and a second spring 112.

The suction device 100 also includes an inner housing 114, an outer housing 116, and a ring plate 118. Together with the ring plate 118, the outer housing 116 is mounted on a vacuum member 16″. Between the outer housing 116 and the ring plate 118, ventilation channels 120 connect the inside of the mount unit 114 with surrounding atmosphere.

Constrained by the first spring 110, the pin 104 is movable within the inner housing 114 and, constrained by the second spring 112, the inner housing 114 is movable within the outer housing 116.

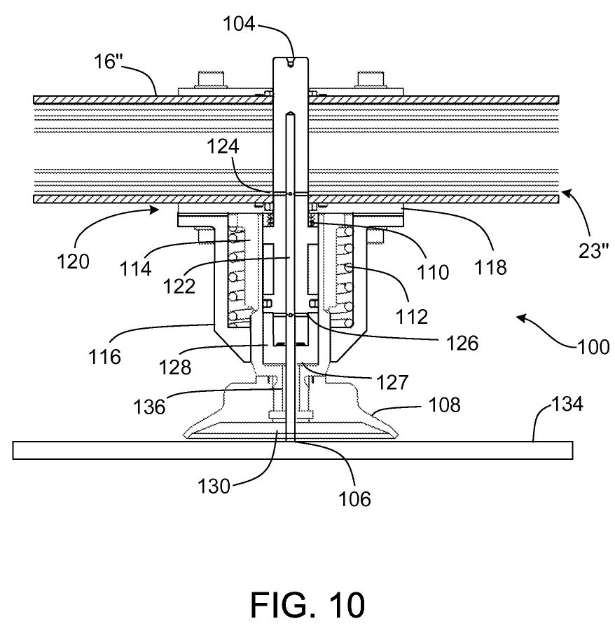

The pin 104 provides a channel system 122 between a first set of openings 124 and a second set of openings 126. The first set of openings 124 can be moved into fluid communication with a vacuum passage way 23″ or with the ventilation channels 120. The second set of openings is in flow connection with a vacuum chamber 128 that is formed between the pin 104 and the inner housing 114. A suction volume 130 is defined by the suction cup 122 and an attached element 134, as shown in FIG. 10. FIG. 10 also shows that the vacuum chamber 128 can be in flow communication with the suction volume 130 through an opening 136 in the inner housing 114.

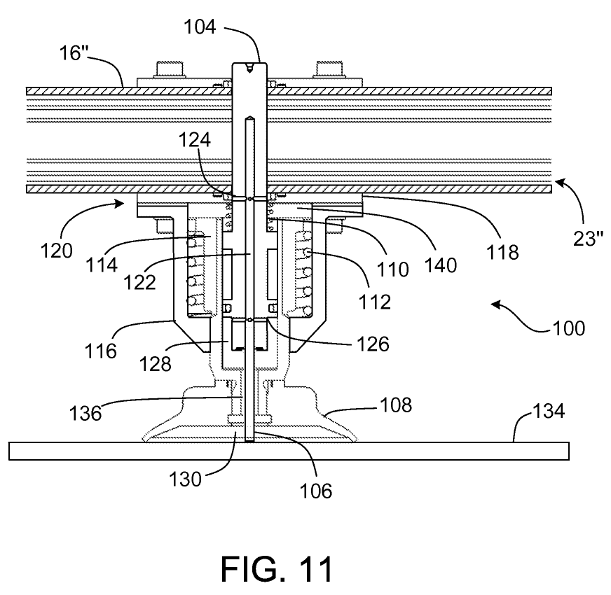

During operation of the suction device 100, the pin 104 and the inner housing 114 are movable between an initial position, shown in FIG. 9, and an evacuation position, shown in FIG. 10, in which the element 134 (cut part or skeleton) is attached to the suction cup 108. In order to break the vacuum and release the skeleton, the first set of openings 124 is positioned to overlap with the ventilation channels 120 or a volume 140 that is created when the inner housing 114 is moved away from the ring plate 118 (FIG. 11). The volume 140 is in fluid communication with the ventilation channels 120. The openings 124 are drawn downward into this position when the suction device is pulled downward by the holding force applied by the skeleton holders.

In FIG. 9, the suction device 100 is shown in an initial position, in which the first spring 110 positions the pin 104 with respect to the inner housing 114 and the second spring 112 positions the inner housing 114 with respect to the outer housing 116. In the initial position, the vacuum passage way 23″ of the vacuum member 16″ is sealed by the pin 104. Additionally, the suction volume 130 is sealed from the vacuum chamber 128, as discussed above.

When the actuating pin 106 moves upward within the inner housing 114 (FIG. 10), e.g., when the pin 106 is pushed against a surface of the element 134, compressing spring 110, openings 124 move into communication with the volume 140 (FIG. 11).

The evacuation of a volume of the suction device 100 is initiated as soon as the first set of openings 124 is aligned with the vacuum passageway 23″. The evacuatable volume includes the channel system 122, the vacuum chamber 128, the opening 136, and the suction volume 130. In the operating state shown FIG. 10, the evacuatable volume has a lower pressure than the surrounding atmosphere and the element 134 is vacuum attached to the suction cup 108.

FIG. 11 shows a position of the suction device 100 in which the spring 110 has moved to an uncompressed state and the pin 104 is being pushed downward. In the case shown in FIG. 11, the element 134 is part of the skeleton, and the suction device will move to the position shown in FIG. 11, and beyond it, to a release position (not shown) due to the force applied by the skeleton holder 46 (FIG. 4), as discussed above.

The movement of inner housing 114 is biased by the force of the spring 112. As soon as the first set of openings 124 aligns with volume 140, the volume fills with atmospheric air and the vacuum attachment breaks, thereby releasing the element 134 and allowing the spring 112 to move the inner housing 114, the suction cup 108, and the pin 104 back to the initial position.

Other embodiments are within the scope of the following claims.

What is claimed is:

1. A part separation device for separating cut parts from a surrounding skeleton, the device comprising:
a frame defining a vacuum passageway;
attached to the frame, an array of suction devices, each suction device being movable between a normal self-sealed position, a pick-up position, and a release position; and
attached to the frame, at least one skeleton holder being configured to apply a release force to the skeleton thereby moving any suction devices in contact with the skeleton from the pick-up position to the release position, thereby releasing the skeleton from the suction devices.

2. The part separation device of claim 1, wherein each suction device comprises a member defining a vacuum passage terminating in a suction opening, and at least one spring element configured to bias the member.

3. The part separation device of claim 2, wherein the suction devices are configured so that, in the pick-up position, the vacuum passage of the member is in flow connection with the vacuum passageway of the frame.

4. The part separation device of claim 1, wherein the release force acts in a direction opposite to a direction of a suction force of the suction devices.

5. The part separation device of claim 1, wherein each of the suction devices comprises a check valve that is movable between a closed position, corresponding to the self-sealed position of the suction device, and an open position.

6. The part separation device of claim 5 wherein each of the suction devices comprises a vent configured to allow a small amount of leakage past the check valve when the check valve is in the closed position.

7. The part separation device of claim 2, wherein each suction device further comprises a housing, the housing surrounding the member and forming a vacuum chamber between the member and the housing, the vacuum chamber being connected to the suction opening of the member.

8. The part separation device of claim 7, wherein the spring element comprises a first spring acting between the member and the mount and a second spring acting between the housing and the mount.

9. The part separation device of claim 9, wherein the member comprises an actuating extension for contacting a work piece to be attached to the suction cup.

10. The part separation device of claim 8, wherein each suction device is configured so that the member is movable by the first spring into a release position when a release force is applied to the housing.

11. The part separation device of claim 1 wherein each skeleton holder includes an outer housing and an extendable member, telescopically disposed within the housing, the extendable member being configured to apply the release force.

12. The part separation device of claim 1, further comprising a workpiece support configured to support the skeleton.

13. The part separation device of claim 12, further comprising a translation stage configured to move the frame relative to the workpiece support.

14. A method for separating a cut piece from a skeleton of a workpiece, the method comprising:
supporting the workpiece on a workpiece support;
vacuum attaching a first suction device to the cut piece and a second suction device to the skeleton, the suction devices being mounted on a frame;
moving the frame away from the workpiece support to pull the cut piece from the skeleton; and
holding the skeleton down against the workpiece support to release the second suction device and separate the cut piece from the skeleton.

15. The method of claim 14 further comprising applying a blow out pressure to the first suction device to release the cut part from the first suction device.

16. The method of claim 14 wherein holding the skeleton down comprises actuating a skeleton holder that is mounted on the frame.

17. The method of claim 16 wherein actuating the skeleton holder comprises extending an extendable portion of the skeleton holder to maintain contact between the skeleton holder and the skeleton as the frame is moved away from the workpiece support.
